(19) United States
(12) Patent Application Publication
(10) Pub. No.: US 2007/0249333 A1
(43) Pub. Date: Oct. 25, 2007

(54) Apparatus and Method for Providing Poc Service in Wireless Communication System Supporting Bcast Service

(76) Inventors: Sung-Oh Hwang, Gyeonggi-do (KR); Joon-Goo Park, Gyeonggi-do (KR); Sung-Ho Choi, Gyeonggi-do (KR); Sung-Jin Park, Gyeonggi-do (KR)

Correspondence Address: THE FARRELL LAW FIRM, P.C., 333 EARLE OVINGTON BOULEVARD, SUITE 701, UNIONDALE, NY, 11553, US

(21) Appl. No.: 11/660,839

(22) PCT Filed: Aug. 12, 2005
(86) PCT No.: PCT/KR05/02647

§ 371 Date: Feb. 20, 2007

(30) Foreign Application Priority Data
Aug. 17, 2004 (KR) 10-2004-0064899

(51) Int. Cl. H04B 7/00

(52) U.S. Cl. 455/422.1

(57) ABSTRACT

an Disclosed are a method and an apparatus for providing a PoC service in a radio communication system supporting a BCAST service. For the PoC service in the radio communication system supporting the BCAST service, a first terminal joining the PoC service through the BCAST service transmits user data for the PoC service over an uplink dedicated bearer, and the user data reach a PoC server, which controls the PoC service, over the uplink dedicated bearer. The PoC server transmits the user data to a BCAST server controlling the BCAST service and, from the BCAST service server, the user data reach plural second terminals joining the PoC service over a downlink shared bearer. In this way, radio resources can be efficiently used when the PoC service is performed in a random area, and an a BCAST service operator d a PoC service operator is provided.

### TECHNICAL FIELD

The present invention relates to a radio communication system supporting a broadcast service (hereinafter referred to as ‘BCAST service’), and more particularly to a method and an apparatus for efficiently implementing a Push to Talk over Cellular service (hereinafter referred to as ‘PoC service’) over a cellular mobile communication network.

### BACKGROUND ART

Nowadays, owing to the development of communication technologies, a radio communication system not only provides conventional point-to-point voice services, but also is evolving into a radio communication system which provides packet service communications for transmission of mass data such as packet data, circuit data and the like. Also, with the advance in the packet communications, a core network (hereinafter referred to as ‘CN’) is being provided with equipments based on Internet Protocol (hereinafter referred to as ‘IP’) technologies. As the IP-based equipments have been installed in the CN, it has also become possible to provide a PoC service as well the conventional point-to-point voice service. The PoC service is based on a packet network as the CN, so it can be used for packet transmissions as well as the voice services. By transmitting the contents of voice or packet calls of authorized users, from among plural users who join the service, to the plural users, the PoC service allows the plural users not to have to set up point-to-point calls one by one for information sharing.

FIG. 1 illustrates an example of a mobile communication system which implements a PoC service.

Referring to FIG. 1, a terminal 101 is connected to a CN 130 through a radio access network (hereinafter referred to as ‘RAN’) 110 and a terminal 103 is connected to the CN 130 through an RAN 120. The RAN 110 consists of a radio network controller (hereinafter referred to as ‘RNC’) 111 and cell A (that is, node B or a base station) 113, and may control plural cells other than the cell A 113. A typical RAN technology includes code division mobile communication access network technologies according to US IS-95 series, GSM (Global System for Mobile Communications) using time division mobile communication technologies, 3GPP2 (3rd Generation Partnership Project 2) which is the 3^{rd} generation synchronous mobile communication standard, UMTS (Universal Mobile Telecommunication Service) proposed in 3GPP, which is the 3^{rd} generation asynchronous mobile communication standard, and so forth. Although using different direct names from each other, such different radio access technologies have entities serving as the RNC 111 and the cell A 113, respectively.

The CN 130 includes a packet service (hereinafter referred to as ‘PC’) domain server 131, a PoC server 135 and a PS domain server 133. In addition to entities shown in FIG. 1, an entity providing a circuit domain service, an entity used for connection to another CN and an entity used for subscriber authentication and security exist in the CN 130, but they are not shown in the drawing. The PS domain server 131 has an authentication function for a user or a user terminal desiring a packet service and a supporting function for the packet service which the user or user terminal desires. Such functions refer to functions of authentication for using the PS domain, mobility management, data transmission/reception, data transmission/reception control and the like. The PoC server 135, an entity capable of supporting a PoC service, enables the users or user terminals desiring the PoC service to push to talk over cellular while divided into appropriate groups according to the desired services.

On the basis of the above-mentioned FIG. 1, an example in which the terminals 101, 103 use the PoC service will be described below.

The terminals 101, 103 request permissions to use the RANs to the RNCs 111, 121 through the cells A and B 113, 122, respectively. With respect to the permissions to use the RANs, the RNCs 111, 121 set up bearer information for radio accesses and transmit the bearer information as replies to the requests for the permissions to use the RANs to the terminals 101, 103. Here, the bearer refers to paths by way of which user data and control information related to the user data are transmitted between each entities and between end entities, and the control information inclusively refers to radio channel information, wired channel information and information on logic channels for protocols used in the RANs.

The terminals 101, 103, having received the permissions of accesses to the RANs and the bearer information, transmit requests for permissions to use PS domains to the PS domain servers 131, 133 through the bearers which are set up using the bearer information set up in the RANs 110, 120, respectively. The PS domain server 131 or 133 has different names in every mobile communication technology and standard. As an example, it is called ‘SGSN (Serving GPRS Service Node)’ in the 3GPP, and is called ‘PDSN (Packet Data Service network)’ in the 3GPP2. After the terminals 101, 103 pass user authentications, the PS domain servers 131, 133 transmit rights of using the PS domains and information on bearers to be used in the PS domains to the terminals 101, 103. Here, a detailed description of subscriber authentication procedures for the terminals 101, 103 is omitted, and a detailed description of procedures between the RANs 110, 120 and the CN 130, which are necessary for the terminals 101, 103 to transmit/receive data to/from the CN 130 via the RANs 110, 120, is also omitted.

The terminals 101, 103, having acquired the rights of using the PS domains and the information on bearers to be used in the PS domains, transmit requests for using a PoC service to the PoC server 135. The PoC server 135 is a logic entity having functions to provide and control the PoC service. The PoC server 135 sets up a group ID which the terminals 101, 103 will use in the PoC service, and transmits all control information for the PoC service to the respective terminals 101, 103. In this way, the terminals 101, 103 come to acquire all information necessary for the POC service.

When the user of the terminal 101 has any matter to be transmitted, the terminal 101 requests data transmission to the PoC server 135, and the PoC server 135 determines if the request is to be approved. The determination of approval by the PoC server 135 is very important because several hundreds of terminals have permissions to use the service in the actual PoC service. If the PoC sever 135 approves the data transmission to the terminal 101, then the terminal 101 transmits data to the PoC server 135. The PoC server 135 transmits the data of the terminal 101 to the terminal 103 and also transmits the data to other terminals which join the same PoC service together with the terminal 101. When the terminal 103 has any matter to be transmitted, the same procedures are also carried out.

As described in FIG. 1, the PoC service has a multipoint communication characteristic. However, in view of actual data transmission, bearers having point-to-point correspondences between the respective terminals 101, 103 and the CN 130 must be set up. The respective terminals transmit/receive data over dedicated bearers in uplink and downlink transmission. In an uplink path, it is reasonable to use the dedicated bearers in an uplink path because each user data is transmitted. However, since data transmitted over a downlink path is common to all the terminals, the dedicated bearers for each terminals may cause a waste of wired/radio resources.

Although FIG. 1 shows only one terminal in the cell A 113, when a plurality of terminals using the same PoC service in an office, a factory or a narrow area exist, that is, a plurality of terminals exist under one cell, the CN 130 and the RAN 110 must set up as many bearers as there are terminals in order to transmit data having the same contents, so a waste of wired/radio resources is caused.

### DISCLOSURE OF INVENTION

### Technical Problem

Accordingly, the present invention has been made to solve at least the abovementioned problem occurring in the prior art, and an object of the present invention is to provide a method and an apparatus for applying a BCAST service to efficiently use wired/radio resources in a mobile communication system supporting a PoC service.

A further object of the present invention is to provide a method and an apparatus for efficiently transmitting data and control information between a main operating body providing a PoC service and a main operating body providing a BCAST service.

A further object of the present invention is to provide an efficient operation method for a main operating body of a PS domain in providing PoC and BCAST services.

A further object of the present invention is to provide an efficient operation method for a main operating body of an RAN in providing PoC and BCAST services.

A further object of the present invention is to provide an efficient operation method for a terminal in providing PoC and BCAST services.

To accomplish these objects, in accordance with one aspect of the present invention, there is provided a method for providing a PoC service in a radio communication system supporting a BCAST service, the method comprising the steps of:

transmitting, by a first terminal joining the PoC service through the BCAST service, user data for the PoC service over an uplink dedicated bearer; passing the user data through a first RAN serving the first terminal and a second PS domain server over the uplink dedicated bearer to reach a PoC server controlling the PoC service; transmitting, by the PoC server, the user data to a BCAST server controlling the BCAST service;

and passing the user data from the BCAST server to a second PS domain server, which serves a plurality of second terminals joining the PoC service, and passing the user data through a second RAN to reach the plurality of second terminals over a downlink shared bearer.

### BRIEF DESCRIPTION OF THE DRAWINGS

The above and other objects, features and advantages of the present invention will be more apparent from the following detailed description taken in conjunction with the accompanying drawings, in which:

FIG. 1 is a view illustrating an example of an architecture in which a POC service is provided in a radio communication network;

FIG. 2 is a view illustrating an example an architecture in which a PoC service is provided in a radio communication network supporting a BCAST service;

FIG. 3 is a flowchart illustrating signaling between a terminal, a main operating body of a BCAST service and a main operating body of a PoC service in accordance with a preferred embodiment of the present invention;

FIG. 4 is a flowchart illustrating operations of a main operating body of a BCAST service in accordance with a preferred embodiment of the present invention;

FIG. 5 is a flowchart illustrating operations of a main operating body of a PoC service in accordance with a preferred embodiment of the present invention;

FIG. 6 is a flowchart illustrating operations of an entity controlling a packet network in accordance with a preferred embodiment of the present invention;

FIG. 7 is a flowchart illustrating operations of an entity controlling an RAN in accordance with a preferred embodiment of the present invention; and

FIG. 8 is a flowchart illustrating operations of a terminal in accordance with a preferred embodiment of the present invention.

### BEST MODE FOR CARRYING OUT THE INVENTION

Hereinafter, preferred embodiments of the present invention will be described with reference to the accompanying drawings. It should be noted that the similar components are designated by similar reference numerals although they are illustrated in different drawings. Also, in the following description, a detailed description of known functions and configurations incorporated herein will be omitted when it may obscure the subject matter of the present invention.

Nowadays, owing to the development of communication technologies, a mobile communication system not only provides conventional voice services, but also is evolving into a mobile communication system which provides packet service communications for transmission of mass data such as packet data, circuit data, etc., and provides multimedia broadcast/multicast communications for transmission of multimedia services. Therefore, in order to support the multimedia broadcast/multicast communications, there has been devised a BCAST service which provides services from one or more multimedia data sources to a plurality of terminals.

The BCAST service supports real-time images, voices, still images, characters, etc., and requires a lot of transmission resources. Considering that plenty of services may be simultaneously deployed within one cell or a certain area, the BCAST service is provided through broadcast channels. Also, the BCAST service includes a number of technologies such as a multimedia broadcast/multicast service (MBMS) of the 3GPP, a broadcast multicast service (BCMCS) of the 3GPP2, and digital multimedia broadcasting (DMB) and digital video broadcasting (DVB) using a satellite. The BCAST service may be divided into a point to point (hereinafter referred to as ‘PtP’ service which provides services desired by each subscribers, respectively and a point to multi (hereinafter referred to as PtM’ service which provides the same data to a plurality of subscribers.

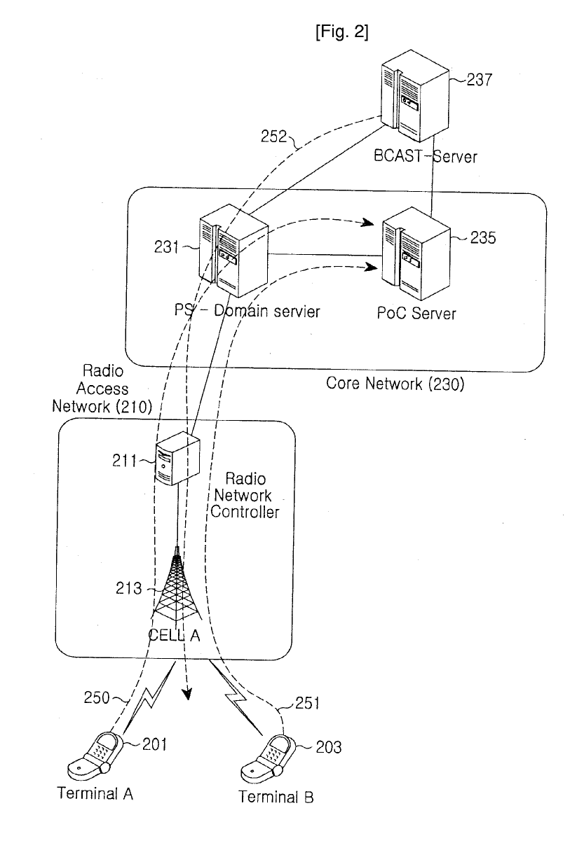

FIG. 2 illustrates an example an architecture in which a PoC service is provided through a BCAST service in accordance with a preferred embodiment of the present invention. In FIG. 2, a CN 230 consists of a BCAST server 237, a PoC server 235 and a PS domain server 231, and other entities are omitted in the drawing because they are not related to the gist of the present invention.

Referring to FIG. 2, the BCAST server 237 is a main operating body logically operating the BCAST service, that is, a logic entity managing the whole functions such as data provision, subscriber authentication, service guide and the like for the BCAST service. In the present invention, the BCAST server 237 constitutes a BCAST service capable of supporting a PoC service for terminals existing in a specific area. The BCAST service supporting the PoC service refers to a service in which uplink data transmitted from terminals joining the PoC service are received from the PoC server 235 and the received data are transmitted to the area, in which the terminals are located, over broadcast channels. Also, the BCAST server 237 notifies the terminals joining the PoC service of service starting, and manages the terminals.

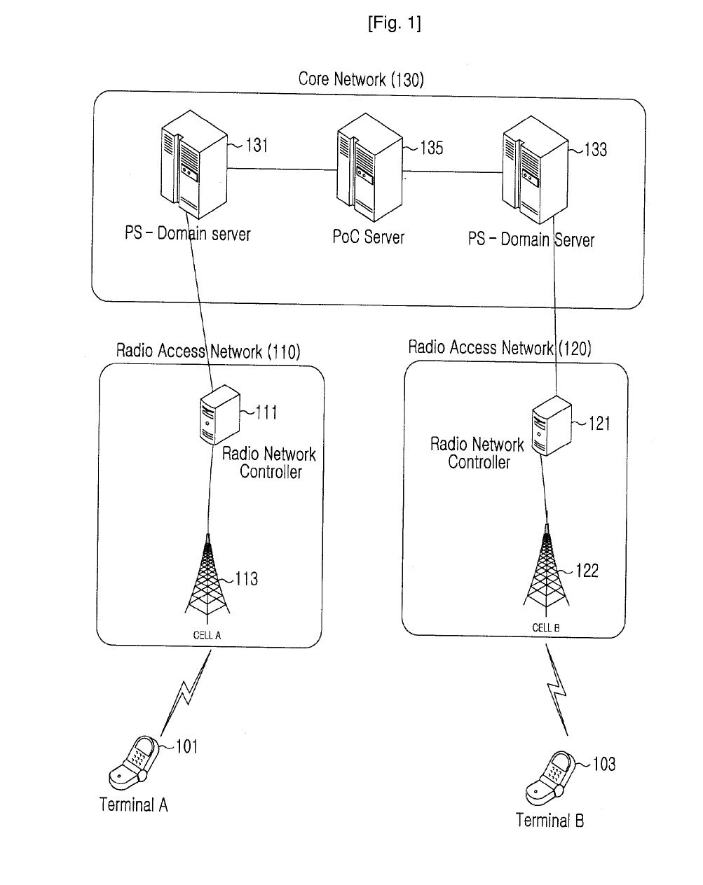

The PoC server 235 transmits uplink data from terminals joining the BCAST service for the PoC service, which the BCAST server 237 provides, to the BCAST server 237, and perform other functions as described in FIG. 1.

The PS domain server 231 serves to authenticate terminals intending to use services provided in a PS domain of the CN 230, such as the PoC service, the BCAST service, etc., and allocate and set up bearers to be used by the terminals in the CN 230.

An RAN 210 consists of an RNC 211 and a cell (i.e., node B or base station) 213. In general, the RAN 210 consists of base stations and a base station controller, the base station controller controls a plurality of base stations, and the base station manages a plurality of cells. The RNC 211 corresponds to the base station controller, and the cell 213 corresponds to any cell of the base station under the control of the RNC 211.

The RNC 211 serves to set up and manage a downlink shared bearer over which downlink data of the BCAST service proposed in the present invention for transmitting the PoC service are transmitted. The RNC 211 also serves to receive the data of the BCAST service from the PS domain server 231, and takes charge of permitting the terminals to use the RAN, setting up the bearers and managing the bearers. Furthermore, the RNC 211 transmits uplink transmission data of the terminals joining the BCAST service for transmitting the PoC service to the PS domain server 231. The cell 213 serves to convert uplink radio signals into downlink wired signals and vise versa, and manage radio signals of the respective terminals.

Terminal A 201 and terminal B 203 is terminals located in a specific area, and is situated within a range capable of receiving the downlink shared bearer from the cell 213. The terminals A and B 201, 203 join the PoC service and the BCAST service for uplink data transmission of the PoC service. The terminals A and B 201, 203 transmits/receives data to/from the cell 213 over radio links 250, 251. The radio links 250, 251 consists of a radio uplink and a radio downlink, the radio uplink is dedicatedly allocated to the respective terminals to transmit data from users of the respective terminals 201, 203, and the radio downlink is a shared link over which the terminals joining the BCAST service and located within the cell A 213 can receive data in common.

That is, in FIG. 2, data from users of the respective terminal 201, 203 are dedicatedly transmitted, and data from any user is transmitted in common to a terminal of another user. In other words, the same data is not transmitted to all the terminals, respectively, thereby not causing a waste of wired/radio resources. Also, by virtue of the BCAST service, not only a single bearer is used for data transmission from the CN 230 to the RAN 210, but also a single shared bearer is used for data transmission from the RAN 210 to the respective terminals 201, 203, so the wired/radio resources are efficiently saved.

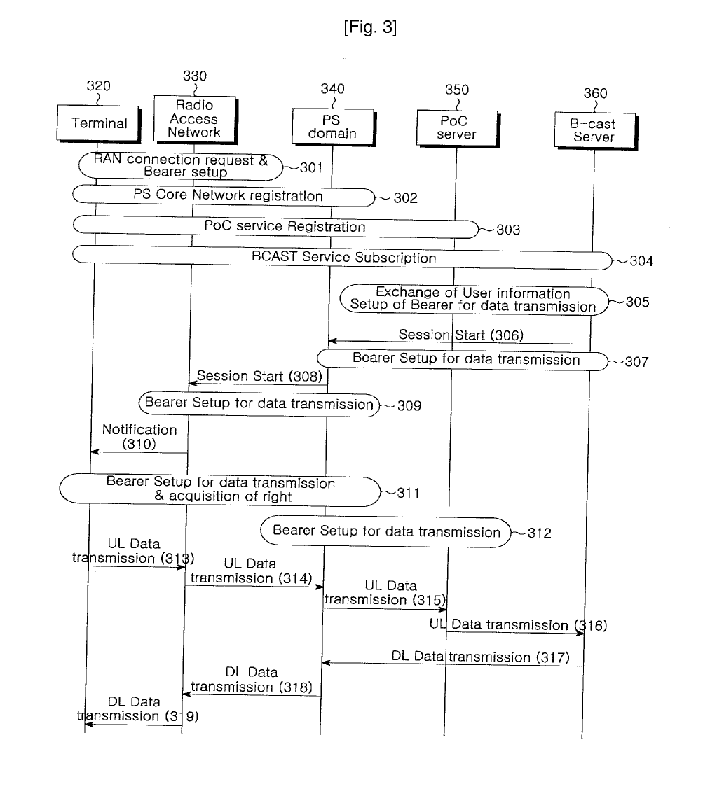

FIG. 3 illustrates signaling between any terminal receiving a PoC service through a BCAST service proposed in the present invention for transmitting the PoC service, a BCAST server, a PoC server, a PS domain server and an RNC.

Referring to FIG. 3, in step 301, the terminal 320 requests the RAN 330 for radio connection and sets up a signaling bearer to be used for the radio connection. In step 301, the terminal 320 receives information on a bearer to be used for the radio connection from the RAN 330 and then, in step 302, performs CN registration with the PS domain server 340 over the signaling bearer set up using the bearer information. In step 302, the PS domain server 340 performs an authentication operation checking whether or not the terminals 320 is entitled to use a PS domain of the CN (hereinafter referred to as ‘PS CN’). At this time, the PS domain server 340 may communicate with a separate authentication server for the authentication operation, but a detailed description thereof will be omitted in order not to obscure the gist of the present invention. If the PS domain server 340 determines the terminal 320 as qualified to use the PS CN, the PS domain server 340 confers with the RAN 330 about setup of a bearer for data transmission from the terminal 320 to the PS domain server 340 to set up information on the bearer to be used by the terminal 320 in the PS CN, and transmits the information to the RAN 330 and the terminal 320.

In step 330, the terminal 320 performs PoC service registration with the PoC server 350 through a PoC service requesting procedure. In step 303, the PoC server 350 performs an authentication operation for the PoC service requested by the terminal 320, and transmits a response to the request to the terminal 320. Independent of step 303, in step 304, the terminal 320 transmits a request for joining the BCAST service to the BCAST server 360. The BCAST server 360 performs an authentication operation for the terminal 320 with respect to the BCAST service requested by the terminal 320, and determines whether or not the request for joining the BCAST service is accepted.

In step 305, the PoC server 350 and the BCAST server 360, having received the requests for joining the PoC and BCASR services, exchange information on the terminal 320 with each other to set up a bearer for receiving uplink transmission data of the terminal 320 transmitted from the PoC server 350. Step 305 is a procedure of exchanging information on a user, who possesses the terminal 320, between the PoC server 350 and the BCAST server 360, and any entity of the PoC server 350 and the BCAST server 360 may start with the information exchange process.

In step 306, the BCAST server 360 transmits a session start message, which notifies the terminal 320 and other terminals not shown in the drawing of the start of the BCAST service for downlink data transmission of the PoC service, to the PS domain server 340. In step 307, the BCAST server 360 sets up a bearer for data transmission between the PS domain server 340 and the BCAST server 360. The session start message is a message which may be transmitted at the start of the service or when data to be transmitted occurs in the BCAST server, and is described with relation to the case where the BCAST service starts first in the present invention. The PS domain server 340 transmits the session start message to the RAN 330 in step 308, and sets up a bearer for transmitting BCAST service data to the RAN 330 in step 309.

In step 310, the RAN 330 notifies the terminals joining the BCAST service of the start of the BCAST service through a notification procedure, and the terminal 320 recognizes the start of the service, which the terminal 320 joins, through a notification message from the RAN 330. In step 311, the terminal 320 sets up a downlink shared bearer for receiving the BCAST service between the terminal 320, the RAN 330 and the PS domain server, and acquires a right for uplink transmission of user data of the terminal 320 from the PS domain server 340 and sets up a dedicated uplink transmission bearer for user data transmission. The intention of acquiring the right for uplink transmission is to prevent collisions of uplink transmissions between a plurality of users performing the PoC service.

In step 312, the PS domain server 340 sets up a bearer for uplink data transmission from the terminal 320 to the PoC server 350.

Steps 301 to 312 have been described as an example of procedures in which a terminal desiring to use the PoC service and the BCAST service joins the two services and bearers for data transmission are set up, and actual points of time of bearer setup may not be in sequence as defined in FIG. 3.

In step 313, the terminal 320 transmits voices of the user or data, which the user intends to transmit to all other users joining the PoC service through the BCAST service, to the RAN 330. In step, the RAN 330 transmits the data from the terminal 320 to the PoC server 350. The PoC server transmits the data to the BCAST server 360 by using the bearer set up in step 305.

In step 317, the BCAST server 360 transmits the uplink data, which has been transmitted from the terminal, to all terminals (not shown), which join the BCAST service for downlink data transmission of the PoC service together with the terminal 320, over the bearer set up in step 305. In step 318, the PS domain server 360 transmits the data of the terminal 320, which has been received from the BCAST server 360, to the RAN 330 over the bearer set up in step 309. In step 319, the RAN 330 transmits the data, which has been transmitted from the terminal 320, to the other terminals joining the BCAST service over the downlink shared data bearer set up for the BCAST service in order to enable the data to be available to the other terminals.

Although not shown, the other terminals also perform uplink data transmission or downlink data reception through the procedures in step 313 to 319.

A scope of the BCAST service for transmitting downlink data of the PoC service may cover one cell or a certain area including plural cells, and is determined according to authority of a service provider or service setup.

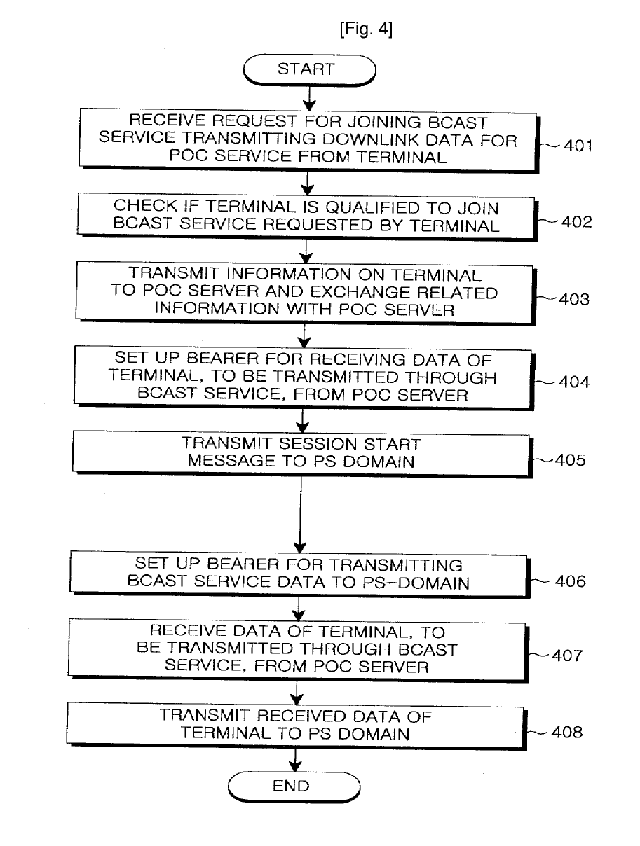

FIGS. 4 to 8 are flowcharts illustrating operations of the BCAST server, the PoC server, the PS domain server, the RAN and the terminal described in FIG. 3, respectively.

FIG. 4 illustrates operations of the BCAST server in accordance with a preferred embodiment of the present invention.

Referring to FIG. 4, in step 401, the BCAST server receives, from the terminal, a request for joining the BCAST service for transmitting downlink data of the PoC service and, in step 402, checks if the terminal is qualified to join the BCAST service in step 402. Such qualification checking may be performed directly by the BCAST server, by a user authentication server of the CN or by the authentication server at the request of the BCAST server.

If the terminal is qualified to join the BCAST service, in step 403, the BCAST server transmits information on the terminal and a user of the terminal to the PoC server and exchanges related information with the PoC server. The related information may include control information for the PoC service which the terminal joins (e.g., ID), a data rate of the PoC service or the like. The related information may also include information on other PoC services which the terminal joins. The BCAST server, having received the information on the other PoC services, determines if all the PoC service which the terminal joins can be transmitted using the BCAST service requested by the terminal, and uses the determination result for set up a bearer for transmitting BCAST data.

In step 404, the BCAST server sets up a bearer for receiving data of the terminal, which is to be transmitted using the BCAST service, from the PoC server.

If it is time to start the BCAST service, in step 405, the BCAST server transmits a session start message to the PS domain server and, in step 406, sets up a bearer for transmitting the BCAST service data to the PS domain. At this time, step 406 may be performed prior to step 405. In step 407, the BCAST server receives the BCAST service data of the terminal from the PoC server and, in step 408, transmits the received data of the terminal to the PS domain server.

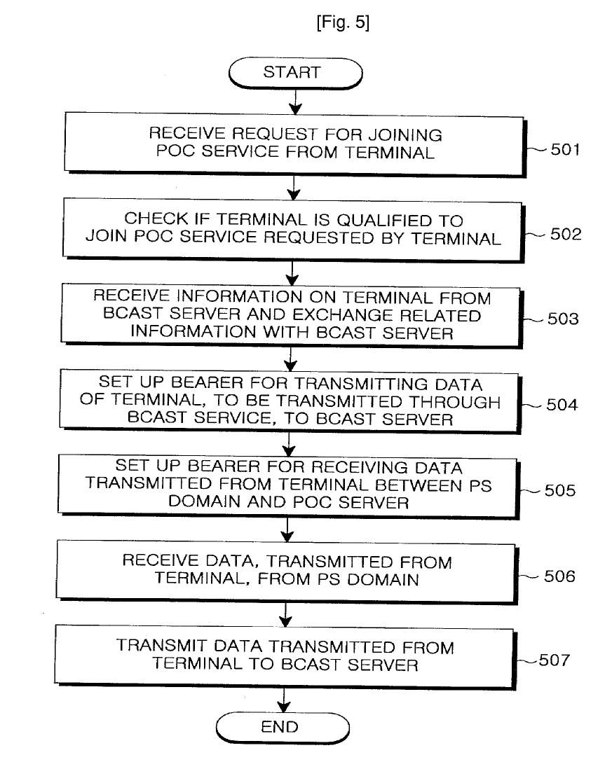

FIG. 5 illustrates operations of the PoC server in accordance with a preferred embodiment of the present invention.

Referring to FIG. 5, in step 501, the PoC server receives a request for joining the PoC service from the terminal. The PoC service refers to a service for transmitting data from the terminal to all other terminals over a shared bearer by using the BCAST service. In step 502, the PoC server checks if the terminal is qualified to join the PoC service. Such qualification checking may be performed directly by the PoC server or using an authentication server in the CN. In step 503, the PoC server receives information on the terminal from the BCAST server and exchanges related information with the BCAST server. At this time, as stated in FIG. 3, information on the terminal intending to use the PoC service may be transmitted from the PoC server to the BCAST server through the BCAST service.

In step 504, the PoC server sets up a bearer for transmitting data of the terminal, which is to be transmitted using the BCAST service, to the BCAST server. In step 505, the PoC server receives data transmitted from the PS domain server and, in step 507, transmits the data to the BCAST server.

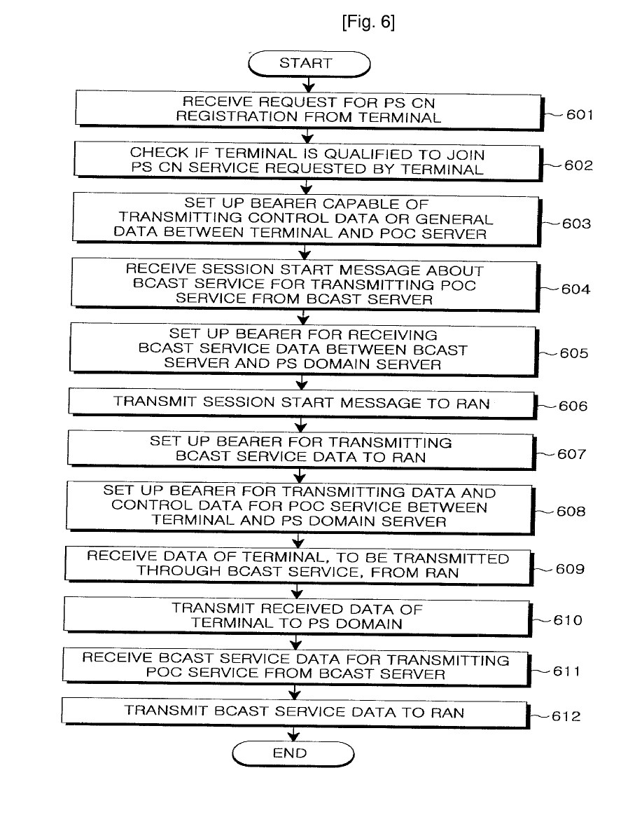

FIG. 6 illustrates operations of the PS domain server in accordance with a preferred embodiment of the present invention.

Referring to FIG. 6, in step 601, the PS domain server receives a request for PS CN registration from the terminal and, in step 602, checks if the terminal is qualified to join a PS CN service. The PS CN service refers to a service enabling packet communications through a PS domain of the CN. If the terminal is qualified to join the PS CN service, in step 603, the PS domain server sets up a bearer capable of transmitting control data or general data between the terminal and the PS domain. In step 604, the PS domain server receives, from the BCAST server, a session start message notifying the start of a BCAST service for a PoC service. In step 605, the PS domain server sets up a bearer for transmitting/receiving data of the BCAST service between the BCAST server and the PS domain server. Step 605 may be performed prior to step 604. In step 606, the PS domain server transmits a session start message to the RAN and, in step 6-7, sets up a bearer for the BCAST service data between the RAN and the PS domain server.

In step 608, the PS domain server sets up a bearer for data or control data transmission of the PoC service between the terminal and the PS domain server. In step 609, the PS domain sever receives PoC service data of the terminal for the BCAST service from the RAN and, in step 610, transmits the received data to the PoC server through the PS domain. Also, in step 611, the PS domain server receives BCAST service data for the PoC service from the BCAST server and, in step 612, transmits the received BCAST service data to RAN.

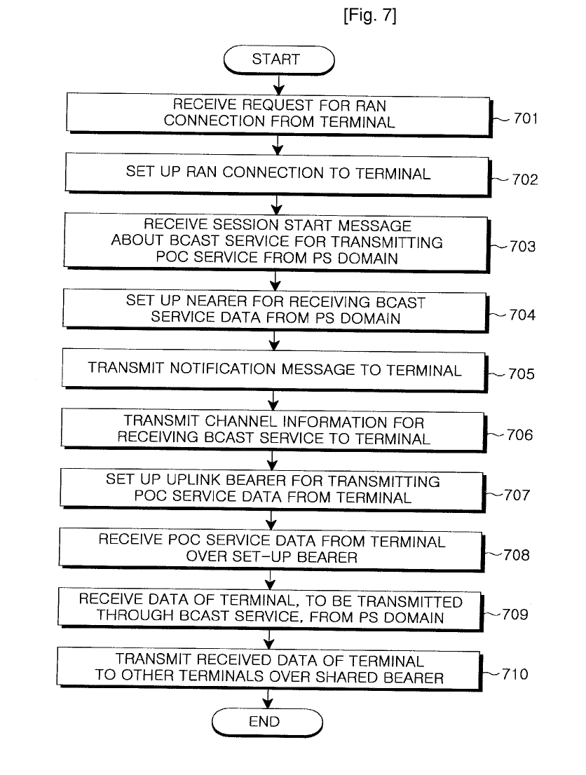

FIG. 7 illustrates operations of the RAN in accordance with a preferred embodiment of the present invention.

Referring to FIG. 7, in step 701, the RAN receives a request for radio connection from the terminal and, in step 702, sets up the radio connection to the terminal. In step 703, the RAN receives, from the PS domain server, a session start message notifying the start of the BCAST service for the PoC service and, in step 704, sets up a bearer for receiving data of the BCAST service between the PS domain server and the RAN. In step 705, the RAN transmits notification messages to terminals joining the BCAST service.

In step 706, the RAN transmits information on channels over which the BCAST service is to be received. The channel information refers to information on a shared bearer for receiving downlink transmission data of the PoC service which the terminals join, and the RAN can save radio resources by using the shared bearer. In step 707, the RAN sets up an uplink dedicated bearer for PoC service data transmission of the terminal and, in step 708, receives the PoC service data from the terminal over the uplink dedicated bearer set up in step 707. In step 709, the RAN receives data of the terminal, which is to be transmitted using the BCAST service, from the PS domain server and, in step 710, transmits the received data to other terminals by using the shared bearer.

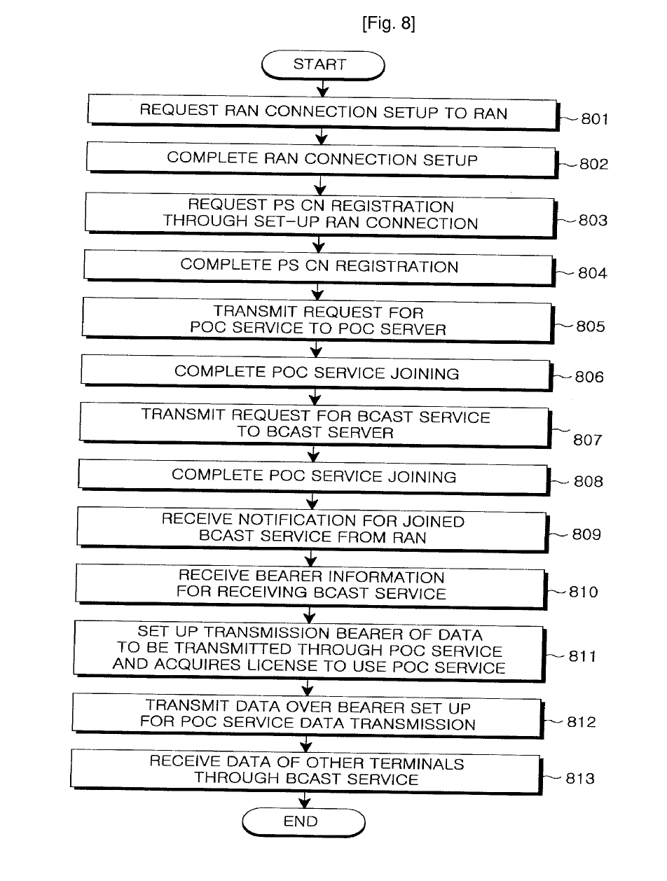

FIG. 8 illustrates operations of the terminal in accordance with a preferred embodiment of the present invention.

Referring to FIG. 8, in step 801, the terminal requests setup of radio connection to the RAN and, in step 802, completes the setup of radio connection. Completing the setup of radio connection means that a bearer for exchanging data with the RAN is completely set up and the terminal can be connected to the CN over the RAN. In step 803, the terminal requests PS CN registration through the set-up radio connection and, in step 804, completes the PS CN registration. Here, completing the PS CN registration means that packet transmission can be effected through a PS domain of the CN, and data can be transmitted to other entities of the PS domain.

In step 805, the terminal transmits a request for the PoC service to the PoC server through the PS domain and, in step 806, completes joining in the PoC service by receiving a response to permit the service joining from the PoC server. In step 807, the terminal transmits a request for the BCAST service and, in step 808, completes joining in the BCAST service.

In step 809, the terminal receives a notification message informing the start of the BCAST service which the terminal joins, and then receives information on a bearer for receiving the BCAST service in step 810. The bearer information for the BCAST service is received over a dedicated bearer or a shared bearer over which all terminals joining the BCAST service can receive the information. In step 811, the terminal sets up an uplink bearer for data transmission through the PoC service and acquires a license to use the PoC service. In step 812, the terminal transmits PoC service data over the bearer set up for data transmission of the PoC service. In step 813, the terminal receives data of other terminals through the BCAST service.

### INDUSTRIAL APPLICABILITY

As described above, by providing a method and an apparatus for performing a PoC service through a BCAST service, the present invention saves wired/radio resources, which may be wasted due to the PoC service, and supports signaling for the PoC service between a main operating body of the PoC service and a main operating body of the BCAST service. That is, it is a main effect of the present invention that wired/radio resources can be saved because PtP data transmission to all terminals joining the PoC service is not performed, but one radio shared bearer and one wired shared bearer are set up for downlink transmission by using the BCAST service. In a situation where various high-speed services are required as radio mobile communications have been evolved, the saving of radio resources means that other services with better qualities can be provided.

While the invention has been shown and described with reference to certain preferred embodiments thereof, it will be understood by those skilled in the art that various changes in form and details may be made therein without departing from the spirit and scope of the invention as defined by the appended claims. For example, in the specification, a PoC service has been described based on a BCAST service which passes through only one PoC server and only one BCAST server. However, for a plurality of PoC servers and a plurality of BCAST servers, it is also possible to implement the PoC service through the BCAST service according to the present invention by means of signaling between the PoC servers and the BCAST servers.

Therefore, the scope of the invention is not limited to the described embodiments and should be defined by not only the appended claims, but also equivalents thereof.

1. A method for providing a PoC service in a radio communication system supporting a BCAST service, the method comprising the steps of:
transmitting, by a first terminal joining the PoC service through the BCAST service, user data for the PoC service over an uplink dedicated bearer;
passing the user data through the uplink dedicated bearer to reach a PoC server controlling the PoC service;
transmitting, by the PoC server, the user data to a BCAST server controlling the BCAST service; and
passing, from the BCAST server, the user data through a downlink shared bearer to reach a plurality of second terminals joining the PoC service.

2. The method as claimed in claim 1, further comprising the step of, if the first terminal and the plurality of second terminals register with the PoC service and join the BCAST service, exchanging information on the first terminal and the plurality of second terminals between the PoC server and the BCAST, and setting up a bearer for the user data transmitted from the PoC server to the BCAST server.

3. A method for operating a BCAST server controlling a BCAST service in a radio communication system supporting a PoC service through the BCAST service, the method comprising the steps of:
transferring information on a terminal requesting the BCAST service for the PoC service to the PoC server controlling the PoC service, and exchanging related information with the PoC server;
setting up an uplink dedicated bearer for the PoC service from the PoC server to the BCAST server;
setting up a downlink shared bearer for the BCAST service between a PS domain server serving the terminal and the BCAST server; and
receiving user data of the terminal for the PoC service from the PoC server over the uplink dedicated bearer, and transmitting the user data from the PS domain server over the downlink shared bearer.

4. A method for operating a PoC server controlling a PoC service in a radio communication system supporting the PoC service through a BCAST service, the method comprising the steps of:
receiving information on a terminal requesting the PoC service through the BCAST service from a BCAST server controlling the BCAST service, and exchanging related information with the BCAST server;
setting up an uplink dedicated bearer for the PoC service from a PS domain server serving the terminal to the BCAST server through the PoC server; and
receiving user data of the terminal for the PoC service from the PS domain server over the uplink dedicated bearer, and transmitting the user data to the BCAST server over the uplink dedicated bearer.

5. A method for operating a PS domain server, which serves a terminal using a PoC service through a BCAST service, in a radio communication system supporting the PoC service through the BCAST service, the method comprising the steps of:
setting up an uplink dedicated bearer from the terminal to the PS domain server over an RAN serving the terminal which requests the PoC service through the BCAST service;
setting up a downlink shared bearer for the BCAST service from the BCAST server controlling the BCAST service to the PS domain server;
transmitting a start message to the RAN and setting up a downlink shared bearer for the BCAST service from the PS domain server to the terminal over the RAN;
receiving user data from the terminal over the uplink dedicated bearer by way of the RAN, and transmitting the user data to the PoC server controlling the PoC service; and
receiving BCAST service data for the BCAST service from the BCAST server, and transmitting the BCAST service data to the terminal over the downlink shared bearer by way of the RAN.

6. A method for operating an RAN, which serves a terminal using a PoC service through a BCAST service, in a radio communication system supporting the PoC service through the BCAST service, the method comprising the steps of:
receiving a request for radio connection from the terminal, and setting up the radio connection;
receiving a start message of the BCAST service for the PoC service from a PS domain server serving the terminal, and setting up a downlink shared bearer from the PS domain server to the RAN;
transmitting channel information of the downlink shared bearer for the PoC service to the terminal, and setting up an uplink dedicated bearer for the PoC service from the terminal to the RAN;
receiving user data from the terminal over the uplink dedicated bearer, and transferring the user data to a PoC server controlling the PoC service through the PS domain server; and
receiving BCAST service data for the BCAST service from the PS domain server, and transmitting the BCAST service data to the terminal over the downlink shared bearer

7. A method for operating a terminal, which uses a PoC service through a BCAST service, in a radio communication system supporting the PoC service through the BCAST service, the method comprising the steps of:
setting up radio connection to an RAN serving the terminal for the PoC service through the BCAST service;
performing PS domain registration with a PS domain server serving the terminal through the radio connection;
performing the PoC service joining for the PoC server controlling the PoC service through the PS domain server;
performing the BCAST service joining for the BCAST server controlling the BCAST service through the PS domain server;
transmitting channel information of a downlink shared bearer for the BCAST service from the RAN, and setting up an uplink dedicated bearer for the PoC service from the terminal to the RAN;
setting up an uplink transmission bearer for the PoC service to transmit user data over the uplink transmission bearer; and
receiving BCAST service data for the BCAST service from the RAN over the downlink shared bearer.

8. An apparatus for providing a PoC service in a radio communication system supporting a BCAST service, the apparatus comprising:
a plurality of terminals joining the PoC service through the BCAST service, transmitting user data for the PoC service over an uplink dedicated bearer and receiving BCAST service data for the PoC service over a downlink shared bearer;
an RAN receiving the user data from any one of the plurality of terminals over the uplink dedicated bearer and transmitting the BCAST service data to the plurality of terminals over the downlink shared bearer;
a PS domain server connected to the RAN for authenticating permissions of using a PS domain for the BCAST and PoC services to the plurality of terminals,
and allocating and setting up the uplink dedicated bearer and the downlink shared bearer for the plurality of terminals;
a BCAST server for controlling the PoC service and transferring the BCAST service data to the PS domain server; and
a PoC sever for controlling the PoC service, receiving the user data from the PS domain server and transferring the received user data to the BCAST server.
